(19) United States
(12) Patent Application Publication
(10) Pub. No.: US 2026/0089593 A1
(43) Pub. Date: Mar. 26, 2026

(54) DYNAMIC CONTEXT HANDLING FOR ROAMING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/322,333

(22) Filed: Sep. 8, 2025

Related U.S. Application Data
(60) Provisional application No. 63/698,425, filed on Sep. 24, 2024.
(60) Provisional application No. 63/728,046, filed on Dec. 4, 2024.
(60) Provisional application No. 63/729,010, filed on Dec. 6, 2024.
(60) Provisional application No. 63/742,308, filed on Jan. 6, 2025.

(51) Int. Cl. H04W 36/08; H04L 1/1607; H04W 8/00; H04W 60/04

(52) U.S. Cl. CPC H04W 36/08; H04L 1/1642; H04W 8/005; H04W 60/04

(57) ABSTRACT

Methods and apparatuses for sequence number (SN) context transfer for next generation Wireless Local Area Networks (WLANs). A method of wireless communication performed by a station (STA) includes initiating a roaming procedure for roaming from a first access point (AP) to a second AP, wherein during the roaming procedure, data of the STA is received by the first AP and a distribution system (DS) remapping procedure is initiated; initiating an SN advancement procedure associated with traffic identifier (TID) information of the data of the STA, the SN advancement procedure for incrementing a value of a SN; and obtaining a value of a first SN at the second AP, where the value of the first SN at the second AP is based on a latest SN of a plurality of SNs at the first AP when the roaming procedure is initiated.

### CROSS-REFERENCE TO RELATED APPLICATION(S) AND CLAIM OF PRIORITY

This application claims priority under 35 U.S.C. § 119(e) to U.S. Provisional Patent Application No. 63/698,425, filed on Sep. 24, 2024, U.S. Provisional Patent Application No. 63/728,046, filed on Dec. 4, 2024, U.S. Provisional Patent Application No. 63/729,010, filed on Dec. 6, 2024, and U.S. Provisional Patent Application No. 63/742,308, filed on Jan. 6, 2025, each of which are hereby incorporated by reference in its entirety.

### TECHNICAL FIELD

This disclosure relates generally to wireless communication, and more specifically to dynamic context handling for roaming in Wireless Local Area Networks (WLANs) including next generation WLANs.

### BACKGROUND

WLAN technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for sequence number context transfer for next generation WLANs.

In one embodiment, a station (STA) comprises: a transceiver, and a processor operably coupled with the transceiver. The processor is configured to: initiate a roaming procedure for roaming from a first access point (AP) to a second AP, wherein during the roaming procedure, data of the STA is received by the first AP and a distribution system (DS) remapping procedure is initiated; initiate a sequence number (SN) advancement procedure associated with traffic identifier (TID) information of the data of the STA, the SN advancement procedure for incrementing a value of a SN; and obtain a value of a first SN at the second AP, where the value of the first SN at the second AP is based on a latest SN of a plurality of SNs at the first AP when the roaming procedure is initiated.

In another embodiment, an AP comprises a transceiver, and a processor operably coupled with the processor. The processor is configured to: perform a roaming procedure associated with a STA roaming from the first AP to a second AP, where during the roaming procedure, data of the STA is received by the first AP and a DS remapping procedure is initiated; and perform a SN advancement procedure associated with TID information of the data of the STA, the SN advancement procedure for incrementing a value of a SN. To perform the SN advancement procedure, the processor is further configured to: determine a value of a latest SN of a plurality of SNs at the first AP when the roaming procedure is initiated; and transmit, via the transceiver to the second AP, information associated with determination of a value of a first SN at the second AP based on the determined value of the latest SN of the plurality of SNs.

In yet another embodiment, a method of wireless communication performed by a STA includes initiating a roaming procedure for roaming from a first AP to a second AP, wherein during the roaming procedure, data of the STA is received by the first AP and a DS remapping procedure is initiated; initiating an SN advancement procedure associated with TID information of the data of the STA, the SN advancement procedure for incrementing a value of a SN; and obtaining a value of a first SN at the second AP, where the value of the first SN at the second AP is based on a latest SN of a plurality of SNs at the first AP when the roaming procedure is initiated.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example of a roaming procedure according to embodiments of the present disclosure;

FIG. 6 illustrates an example of sequence number (SN) counter advancement at a current AP according to embodiments of the present disclosure;

FIG. 7 illustrates an example of an SN counter starting at a target AP according to embodiments of the present disclosure;

FIG. 8 illustrates an example of SN buffer reservation according to embodiments of the present disclosure;

FIG. 9 illustrates an example call flow operation for SN buffer reservation according to embodiments of the present disclosure;

FIG. 10 illustrates an example of a fixed SN offset according to embodiments of the present disclosure;

FIG. 11 illustrates an example call flow operation for fixed SN offset according to embodiments of the present disclosure;

FIG. 12 illustrates an example time limit based SN update according to embodiments of the present disclosure;

FIG. 13 illustrates an example call flow operation with time limit based SN update according to embodiments of the present disclosure;

FIG. 14 illustrates an example SN transfer based on latest SN assignment according to embodiments of the present disclosure;

FIG. 15 illustrates an example call flow operation for SN transfer based on a latest SN assignment according to embodiments of the present disclosure;

FIG. 16 illustrates an example SN remapping at or after distribution system (DS) remapping according to embodiments of the present disclosure;

FIG. 17 illustrates an example call flow operation for SN remapping at or after DS remapping according to embodiments of the present disclosure;

FIG. 18 illustrates an example method of an AP side parameter information message transmission according to embodiments of the present disclosure;

FIG. 19 illustrates an example method of an AP side message transmission procedure according to embodiments of the present disclosure;

FIG. 20 illustrates an example of broadcasting of AP side information according to embodiments of the present disclosure;

FIG. 21 illustrates an example call flow operation for information exchange prior to roaming during preparation phase according to embodiments of the present disclosure;

FIG. 22 illustrates an example call flow operation for information exchange prior to roaming during discovery phase according to embodiments of the present disclosure;

FIG. 23 illustrates an example call flow operation for information exchange at association according to embodiments of the present disclosure;

FIG. 24 illustrates an example method of STA side behavior according to embodiments of the present disclosure;

FIG. 25 illustrates an example method of AP side behavior according to embodiments of the present disclosure;

FIG. 26 illustrates an example call flow operation for pre-roam opt out notification operation according to embodiments of the present disclosure;

FIG. 27 illustrates an example method of a STA procedure for pre-roam opt out for dynamic context transfer according to embodiments of the present disclosure;

FIG. 28 illustrates an example method of a target AP procedure during roam phase dynamic context transfer opt out according to embodiments of the present disclosure;

FIG. 29 illustrates an example element that can carry signaling according to embodiments of the present disclosure; and

FIG. 30 illustrates an example method performed by a STA in a wireless communication system according to embodiments of the present disclosure.

### DETAILED DESCRIPTION

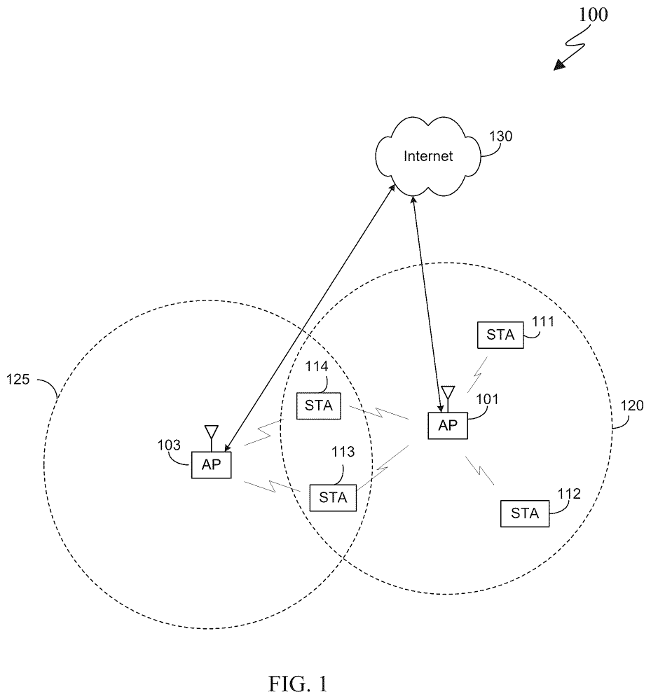

FIGS. 1 through 30, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating sequence number context transfer for next generation WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

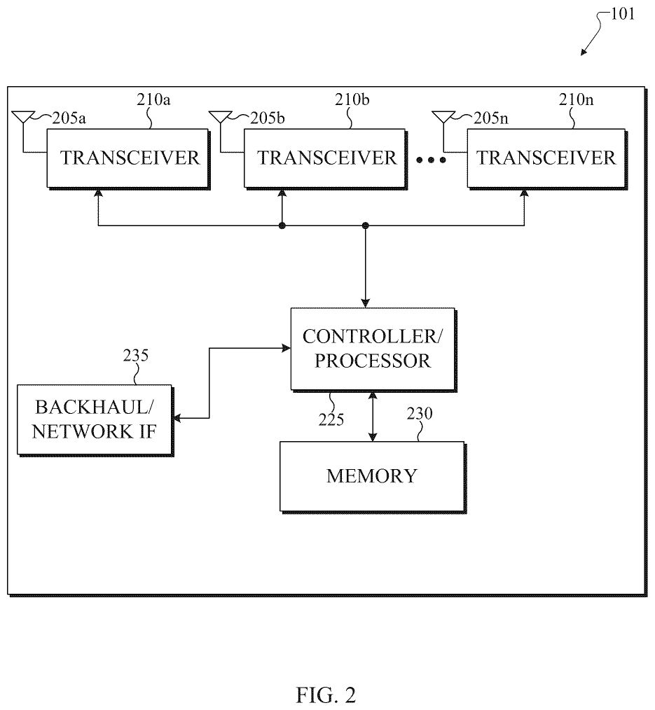

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating sequence number context transfer for next generation WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating sequence number context transfer for next generation WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted, and additional components could be added according to particular needs.

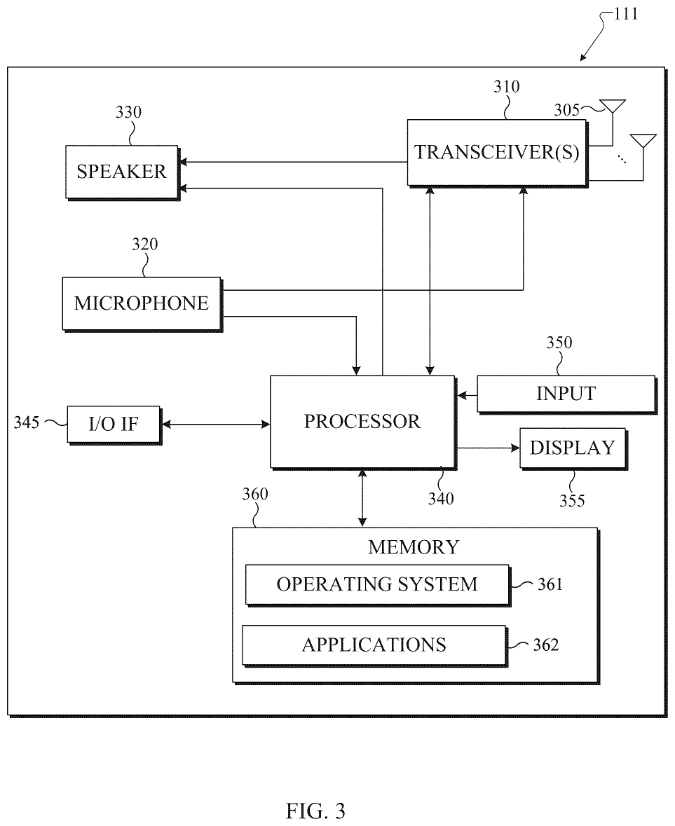

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate sequence number context transfer for next generation WLANs. In some embodiments, the processor 340 includes at least one microprocessor or microcontroller.

The processor 340 is also capable of executing other processes and programs resident in the memory 360, such as operations for facilitating sequence number context transfer for next generation WLANs. The processor 340 can move data into or out of the memory 360 as required by an executing process. In some embodiments, the processor 340 is configured to execute a plurality of applications 362, such as applications for facilitating sequence number context transfer for next generation WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

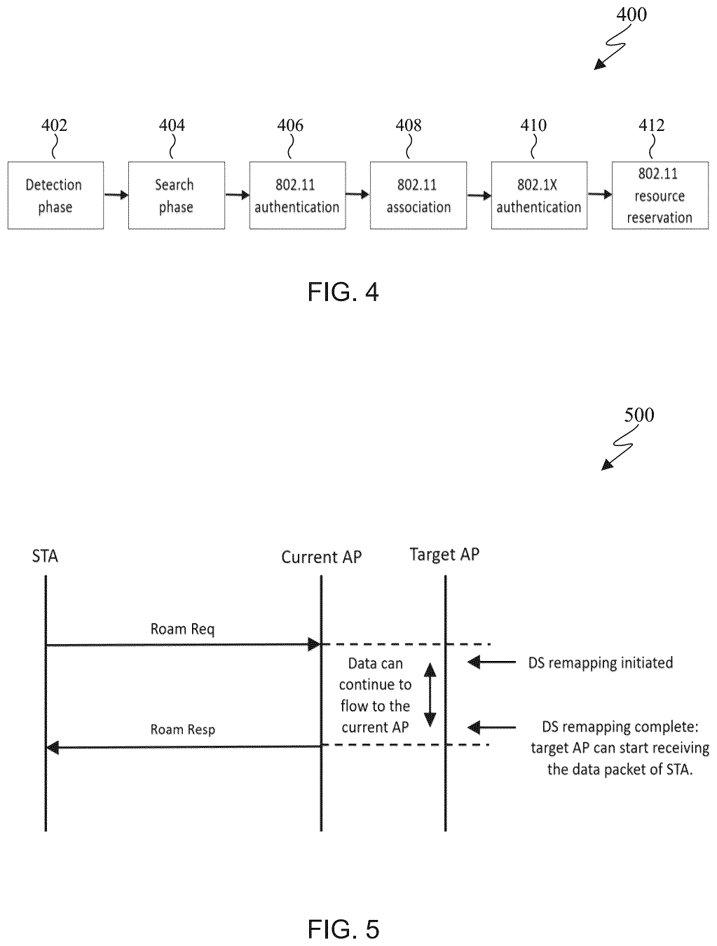

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in legacy devices without any mobility support, the handover procedure involves the following steps:
1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.
2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.
3. 802.11 authentication: after the scanning procedure is complete, the next step is to perform 802.11 authentication 406 (open system/shared key based), where the STA establishes its identity with the AP.
4. 802.11 association: Once the STA is authenticated, the next step is to perform association 408.
5. 802.1X authentication: Introduced in IEEE 802.11 amendment, the 802.1X authentication phase 410 comprises an EAP authentication between the STA and a AAA server with the assistance of the AP.
6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can have an impact on user experience, especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. In IEEE 802.11be, the fast BSS transition procedure was extended to cover the case of MLO operation. This procedure helps to reduce the delays encountered due to 802.11 resource reservation (step 6 above). However, the STA still needs to perform the association and authentication phases which can take 10 s of ms.

### A. Sequence Number Context Transfer

Embodiments of the present disclosure recognize that when roaming is initiated, a DS remapping needs to be completed. The DS remapping can take some time to be completed. In that amount of time, the data of the STA can still continue to be received into the network as the application can still be running on the STA, and the application server can continue to send data to the STA.

A procedure and behavior to handle the data that is received during the roaming procedure, handling the corresponding SN advancement and transfer upon the remapping completion is needed.

FIG. 5 illustrates an example of a roaming procedure 500 according to embodiments of the present disclosure. The roaming procedure 500 of FIG. 5 can be performed by any of the STAs 111-114 of FIG. 1, such as the STA 111 of FIG. 3, and any of the APs 101, 103 of FIG. 1. The embodiment of the roaming procedure 500 shown in FIG. 5 is for illustration only. Other embodiments of the roaming procedure 500 could be used without departing from the scope of this disclosure.

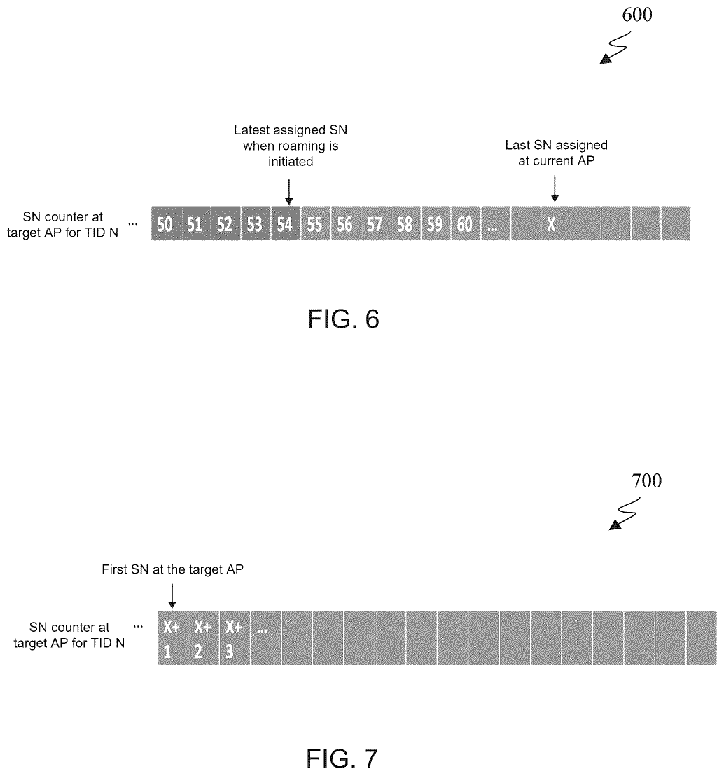

FIG. 6 illustrates an example of SN counter advancement at a current AP 600 according to embodiments of the present disclosure. The embodiment of the SN counter advancement at a current AP 600 shown in FIG. 6 is for illustration only. Other embodiments of the SN counter advancement at a current AP 600 could be used without departing from the scope of this disclosure.

FIG. 7 illustrates an example of a SN counter starting at a target AP 700 according to embodiments of the present disclosure. The embodiment of the SN counter starting at a target AP 700 shown in FIG. 7 is for illustration only. Other embodiments of the SN counter starting at a target AP 700 could be used without departing from the scope of this disclosure.

As illustrated in FIG. 5, a STA can transmit a roam request to its current AP. When roaming is initiated, DS remapping can be initiated. The DS remapping can take some time to be completed and in that amount of time, the data of the STA can still continue to be received into the network as the application can still be running on the STA, and the application server can continue to send data to the STA. After DS remapping is complete, the target AP can start receiving the data packets of the STA.

As illustrated in FIGS. 6-7, while data is continuing to be received by the current AP, the SN counter can be advanced, and the SN counter can start at the target AP based on the last SN at the current AP.

### B. AP Side Parameter Advertisement for Dynamic Context Transfer Skip

Embodiments of the present disclosure recognize that as a part of the seamless roaming procedure, a non-AP can ask the AP to not transfer one or more of its contexts (e.g., dynamic context such as SN/PN). This can help the non-AP to avoid issues arising from longer uplink pauses as the roam procedure is executed, race conditions arising at the time of roam, etc. and to switch to the target AP and start communication at an earlier time.

However, the non-AP may not know if it needs to initiate such a procedure as the current AP/network side can be capable of handling dynamic context in a fast manner without any issues. Without such knowledge, the non-AP's request to initiate such a procedure may not be beneficial for the non-AP's performance. A procedure is needed for the non-AP to identify if it needs to ask the AP to not transfer one or more of its contexts as a part of the roaming procedure.

### C. Pre-Roam Dynamic Context Transfer Skip Procedure

Embodiments of the present disclosure recognize that during seamless roaming, when the STA transmits a roam request to the current AP, the current AP can transfer dynamic context to the target AP. However, there can be a lag in AP to AP communication which can slow down the roaming process. As a result, the STA can request the current AP to opt out of a dynamic context transfer and avoid the resulting issues. It is important that the STA can make a request to the current AP effectively as an opt out message may also need to be conveyed to the target AP and can face the same lag that that can be encountered by dynamic context transfer. A procedure that can enable an efficient opt-out for the STA is needed. Here dynamic context can refer to one or more parameters whose values change on a short time scale, for example sequence number (SN).

Accordingly, embodiments of the present disclosure provide mechanisms for handling sequence number context transfer in next generation WLANs, including: (a) sequence number context transfer; (b) AP side parameter advertisement for dynamic context transfer ship; and (c) pre-roam dynamic context transfer skip procedure.

### (A). Sequence Number Context Transfer

Embodiments of the present disclosure provide mechanisms for (i) SN buffer reservation/SN reserve; (ii) Fixed SN offset; (iii) Time limit based SN update; (iv) SN transfer based on latest SN marking; (v) SN transfer at or after DS remapping; and (vi) Treatment based on per AC/TID.

### B. AP Side Parameter Advertisement for Dynamic Context Transfer Skip

Embodiments of the present disclosure provide mechanisms for (i) AP side parameter info message; (ii) Message transmission; (iii) STA side behavior; (iv) AP side behavior;

### (v) Capability Advertisement

### C. Pre-Roam Dynamic Context Transfer Skip Procedure

Embodiments of the present disclosure provide mechanisms for (i) Opting out of dynamic context transfer during a preparation phase; (ii) Opting out of dynamic context transfer during roam phase; (iii) Example signaling; and (iv) Capability indication.

### A. Sequence Number Context Transfer

### (i). SN Buffer Reservation/SN Reserve

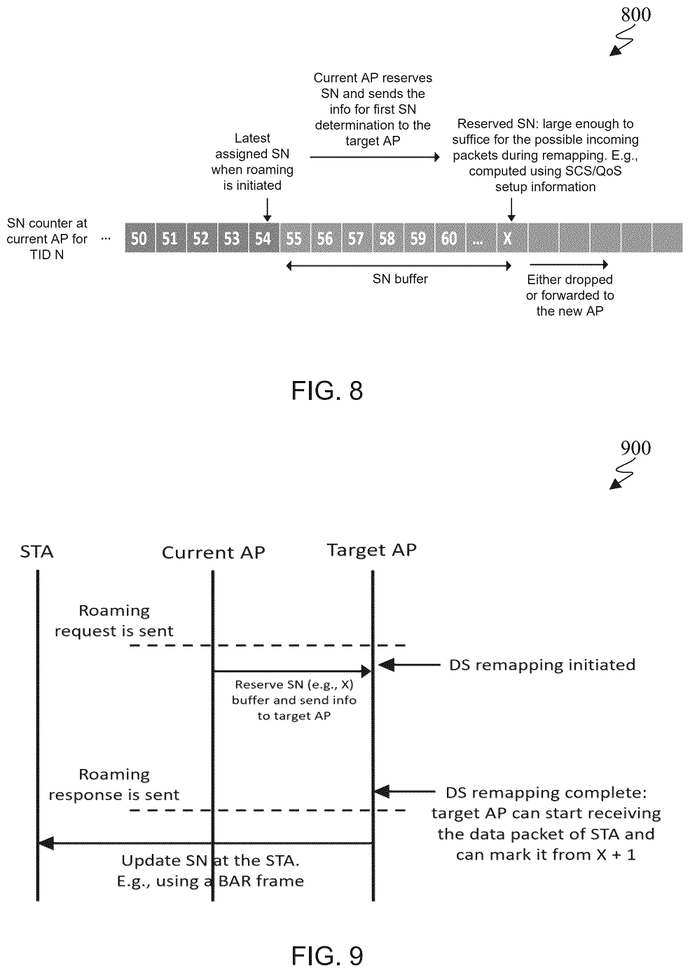

FIG. 8 illustrates an example of SN buffer reservation 800 according to embodiments of the present disclosure. The embodiment of the example SN buffer reservation 800 shown in FIG. 8 is for illustration only. Other embodiments of the example SN buffer reservation 800 could be used without departing from the scope of this disclosure.

As illustrated in FIG. 8, according to some embodiments, the current AP can reserve a certain set of SNs for one or more TIDs when roaming is initiated. The current AP can inform the target AP about the last reserved SN and the target AP can start its marking from that point onwards. The AP can decide the SN buffer size based on a number of parameters known at the AP side. For example, the parameters can be typical DS remapping time, traffic characteristics known from the SCS agreement/QoS parameters exchanged, etc.

FIG. 9 illustrates an example call flow operation 900 for SN buffer reservation according to embodiments of the present disclosure. The call flow operation 900 of FIG. 9 can be performed by any of the STAs 111-114 of FIG. 1, such as the STA 111 of FIG. 3, and any of the APs 101, 103 of FIG. 1. The embodiment of the call flow operation 900 shown in FIG. 9 is for illustration only. Other embodiments of the call flow operation 900 could be used without departing from the scope of this disclosure.

As illustrated in FIG. 9, after roaming is initiated by the STA sending a roaming request, DS remapping can be initiated, and the current AP can reserve a certain set of SNs for one or more TIDs. The current AP can inform the target AP about the last reserved SN and the target AP can start its marking from that point onwards. The current AP can decide the SN buffer size based on a number of parameters known at the AP side. After DS remapping is complete, the target AP can start receiving the data packet of the STA and can mark it from the value of the buffer+1, and the SN can be updated at the STA.

### (ii) Fixed SN Offset

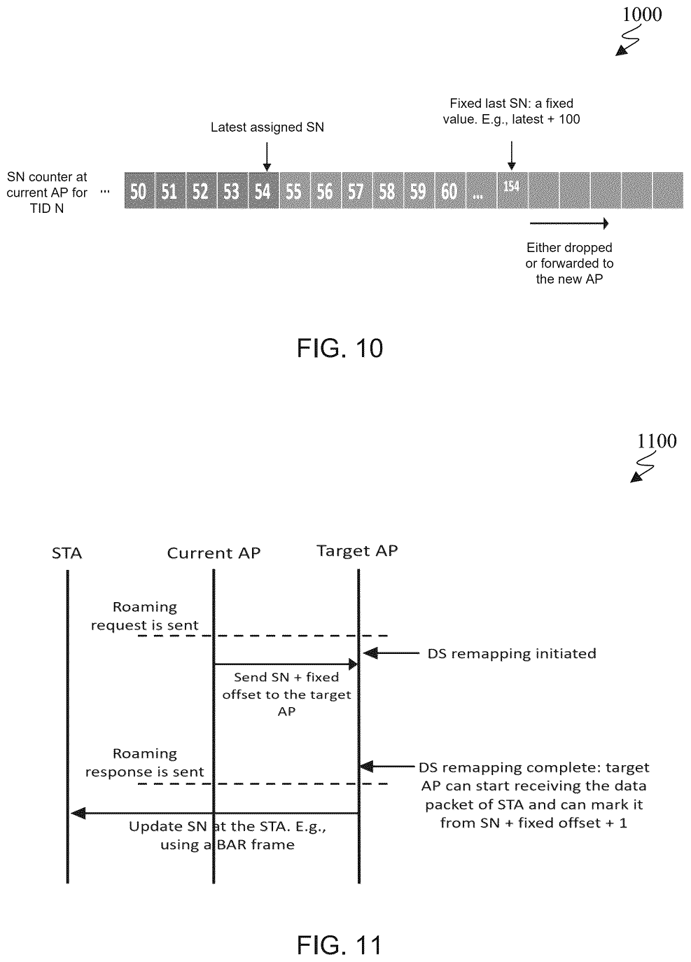

FIG. 10 illustrates an example of a fixed SN offset 1000 according to embodiments of the present disclosure. The embodiment of the example of a fixed SN offset 1000 shown in FIG. 10 is for illustration only. Other embodiments of the example of a fixed SN offset 1000 could be used without departing from the scope of this disclosure.

As illustrated in FIG. 10, according to some embodiments, there can be a fixed offset. When the roaming procedure/DS remapping is initiated, the current AP can fix the last SN and send the information to the target AP.

FIG. 11 illustrates an example call flow operation 1100 for fixed SN offset according to embodiments of the present disclosure. The call flow operation 1100 of FIG. 11 can be performed by any of the STAs 111-114 of FIG. 1, such as the STA 111 of FIG. 3, and any of the APs 101, 103 of FIG. 1. The embodiment of the call flow operation 1100 shown in FIG. 11 is for illustration only. Other embodiments of the call flow operation 1100 could be used without departing from the scope of this disclosure.

As illustrated in FIG. 11, after roaming is initiated by the STA sending a roaming request, DS remapping can be initiated, and the current AP can set a fixed SN offset for one or more TIDs. The current AP can fix the last SN (e.g., the value of the latest assigned SN added to the value of the fixed offset) and send the information to the target AP. After DS remapping is complete, the target AP can start receiving the data packet of the STA and can mark it from the latest SN+fixed offset+1, and the SN can be updated at the STA.

(iii) Time Limit Based SN Update

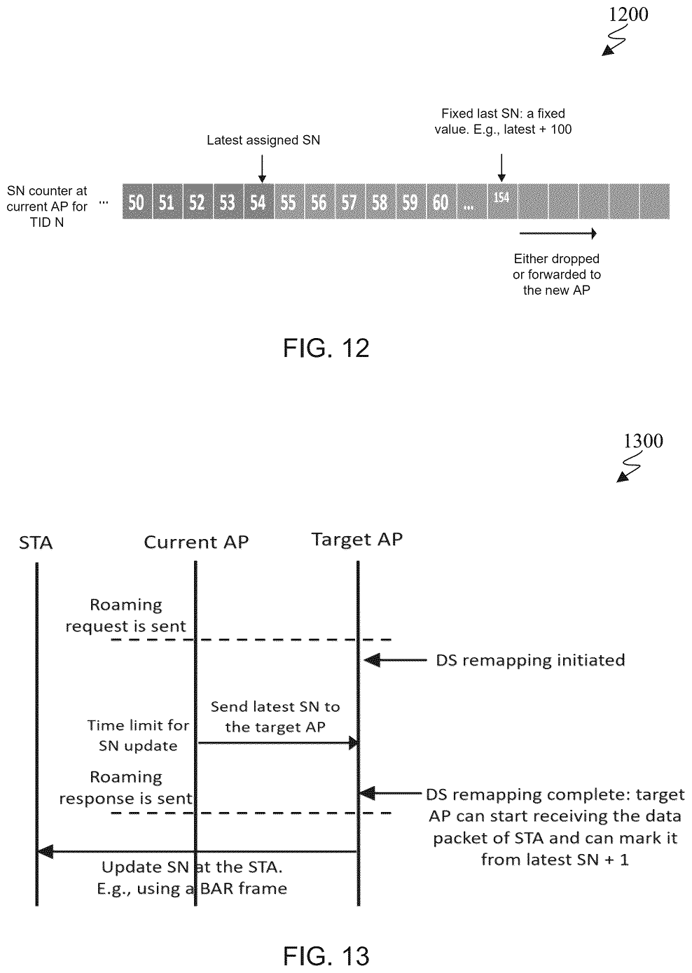

FIG. 12 illustrates an example time limit based SN update 1200 according to embodiments of the present disclosure. The embodiment of the example time limit based SN update 1200 shown in FIG. 12 is for illustration only. Other embodiments of the example time limit based SN update 1200 could be used without departing from the scope of this disclosure.

As illustrated in FIG. 12, according to some embodiments, there can be a time limit based SN update, where the current AP keeps a time limit and advances the SN within that time limit. After the time limit, the SN can be frozen, and the target AP can be updated.

FIG. 13 illustrates an example call flow operation 1300 for a time limit based SN update according to embodiments of the present disclosure. The call flow operation 1300 of FIG. 13 can be performed by any of the STAs 111-114 of FIG. 1, such as the STA 111 of FIG. 3, and any of the APs 101, 103 of FIG. 1. The embodiment of the call flow operation 1300 shown in FIG. 13 is for illustration only. Other embodiments of the call flow operation 1300 could be used without departing from the scope of this disclosure.

As illustrated in FIG. 13, after roaming is initiated by the STA sending a roaming request, DS remapping can be initiated, and the current AP can set a time limit and advance the SN within that time limit. After the time limit, the SN can be frozen, and the target AP can be updated with the latest SN. After DS remapping is complete, the target AP can start receiving the data packet of the STA and can mark it from the target AP can start receiving the data packet of the STA and can mark it from the latest SN+1, and the SN can be updated at the STA.

### (iv) SN Transfer Based on Latest Marking

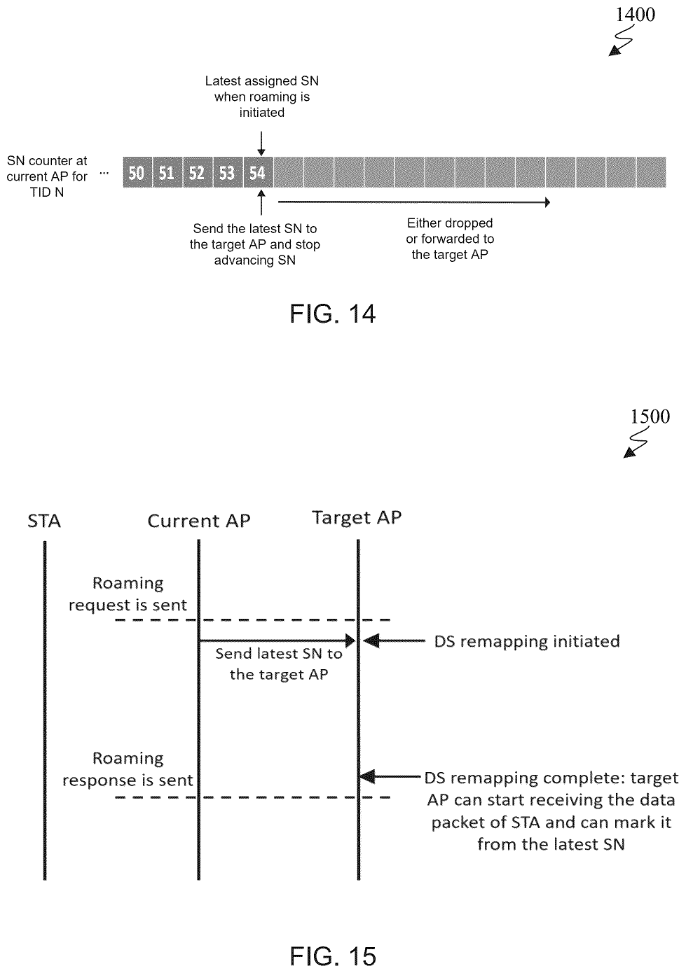

FIG. 14 illustrates an example SN transfer based on a latest assigned SN 1400 according to embodiments of the present disclosure. The embodiment of the example SN transfer based on a latest assigned SN 1400 shown in FIG. 14 is for illustration only. Other embodiments of the example SN transfer based on a latest assigned SN 1400 could be used without departing from the scope of this disclosure.

As illustrated in FIG. 14, according to some embodiments, the latest assigned SN when roaming is initiated can be sent to the target AP and the SN can stop being advanced.

FIG. 15 illustrates an example call flow operation 1500 for a SN transfer based on a latest assigned SN according to embodiments of the present disclosure. The call flow operation 1500 of FIG. 15 can be performed by any of the STAs 111-114 of FIG. 1, such as the STA 111 of FIG. 3, and any of the APs 101, 103 of FIG. 1. The embodiment of the call flow operation 1500 shown in FIG. 15 is for illustration only. Other embodiments of the call flow operation 1500 could be used without departing from the scope of this disclosure.

As illustrated in FIG. 15, after roaming is initiated by the STA sending a roaming request, DS remapping can be initiated, and the current AP can send a latest assigned SN to the target AP. After DS remapping is complete, the target AP can start receiving the data packet of the STA and can mark it from the latest SN.

(v) SN Transfer at or after DS Remapping

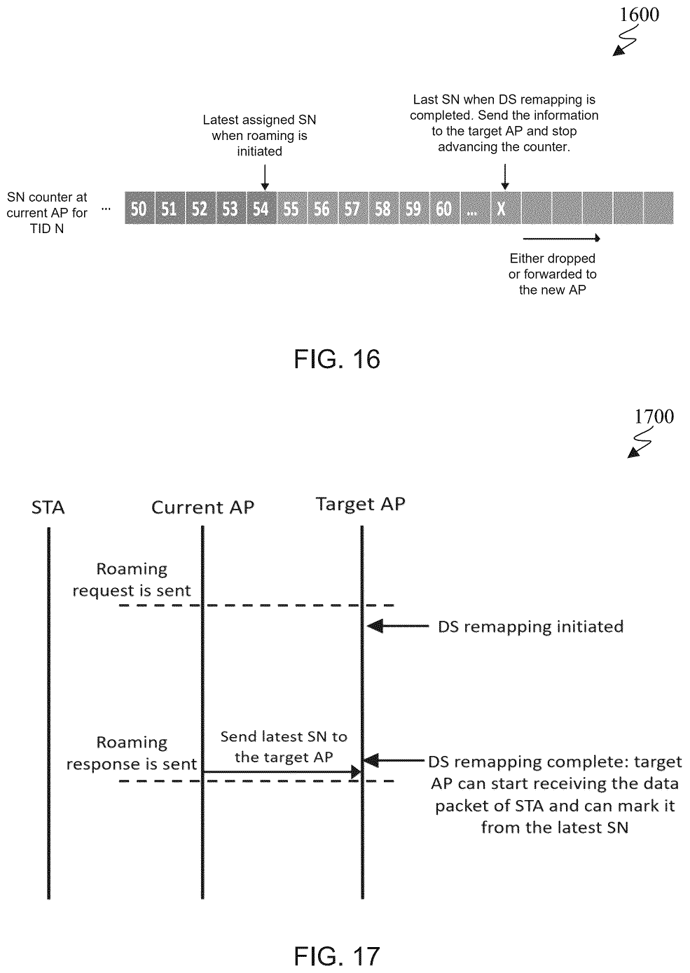

FIG. 16 illustrates an example SN transfer at or after DS mapping 1600 according to embodiments of the present disclosure. The embodiment of the example SN transfer at or after DS mapping 1600 shown in FIG. 16 is for illustration only. Other embodiments of the example SN transfer at or after DS mapping 1600 could be used without departing from the scope of this disclosure.

As illustrated in FIG. 16, according to some embodiments, the SN transfer can be based on the last SN when the DS mapping is completed. The last SN when the DS mapping is completed can be sent to the target AP, and the SN can stop being advanced.

FIG. 17 illustrates an example call flow operation 1700 for a SN transfer based on the last SN when the DS mapping is completed according to embodiments of the present disclosure. The call flow operation 1700 of FIG. 17 can be performed by any of the STAs 111-114 of FIG. 1, such as the STA 111 of FIG. 3, and any of the APs 101, 103 of FIG. 1. The embodiment of the call flow operation 1700 shown in FIG. 17 is for illustration only. Other embodiments of the call flow operation 1700 could be used without departing from the scope of this disclosure.

As illustrated in FIG. 17, after roaming is initiated by the STA sending a roaming request, DS remapping can be initiated and completed. The current AP can send a latest assigned SN when the DS mapping is completed to the target AP. After DS remapping is complete, the target AP can start receiving the data packet of the STA and can mark it from the latest SN when the DS mapping is completed.

### (vi). Treatment Based on Per AC/TID

According to some embodiments, the treatment of the SN transfer can be the same for all the TIDs/ACs.

According to some embodiments, the treatment of the SN can vary from TID to TID or from AC to AC depending on the traffic requirement. For example, for voice streams the treatment can be such that the data flow is not obstructed or delayed. The current AP can continue to serve the flow as long as possible whereas for background traffic the SN of the TID/AC can be transferred to the target AP earlier.

In some embodiments, the policy can be negotiated between the AP and the STA beforehand through a negotiation process.

According to some embodiments, the AP can make the decision based on available information. For example, the AP can decide which AC/TID can be given what treatment based on the information it knows based on SCS/QoS setup.

In some embodiments, the BAR or any other message to update the SN can come from the current AP and can also be transmitted as a part of the roaming response frame. Upon receiving the update, the STA can update the SN to the first SN at the target AP.

### B. AP Side Parameter Advertisement for Dynamic Context Transfer Skip

### (1). AP Side Parameter Info Message

According to some embodiments, there can be an AP side parameter info message transmitted by the AP. The parameter info message can contain information that can enable a non-AP to determine if it can skip the dynamic context transfer or not.

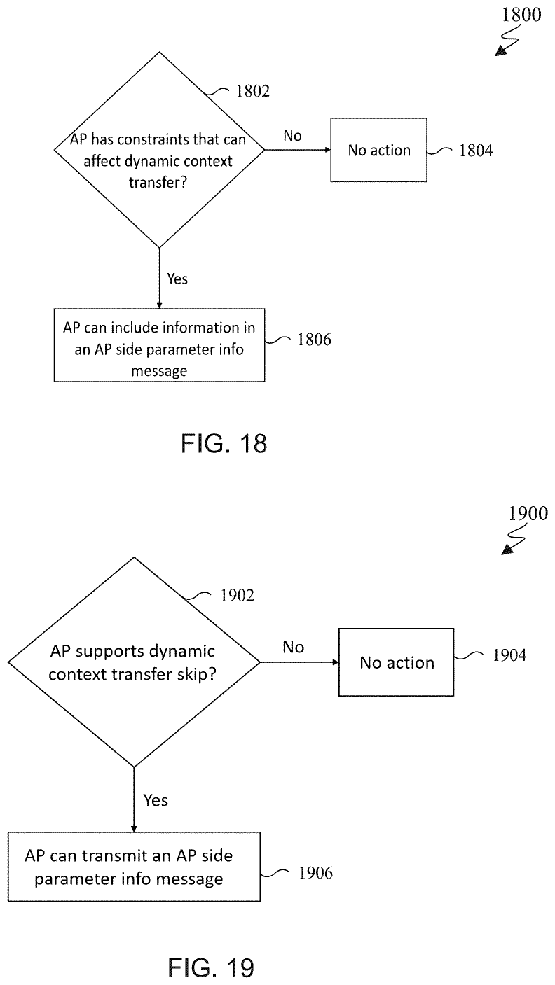

FIG. 18 illustrates an example method 1800 of an AP side parameter information message transmission according to embodiments of the present disclosure. The method 1800 of FIG. 18 can be performed by any of the APs 101, 103 of FIG. 1. The embodiment of the method 1800 shown in FIG. 18 is for illustration only. Other embodiments of the method 1800 could be used without departing from the scope of this disclosure.

As illustrated in FIG. 18, the method 1800 begins at step 1802, where a determination is made whether the AP has constraints that can affect dynamic context transfer. If the AP does not have constraints that can affect dynamic context transfer, then at step 1804, no action is taken. If the AP has constraints that can affect dynamic context transfer, then at step 1806, the AP can include information in an AP side parameter info message. Examples of such information can be at least one of the information items as indicated in Table 1.

TABLE 1
Information items that can be present in the AP side parameter info message

| Information | |
|---|---|
| item | Description |
| Dynamic context | One or more information items that can indicate the time the AP can take |
| transfer time | to transfer dynamic context to a target AP. |
| | This timing information can be indicated for each context separately or |
| | can be a single value applicable for all contexts. |
| | This timing information can be indicated for one or more APs of a |
| | seamless roaming domain and/or one or more neighbor APs of the |
| | transmitting AP and/or one or more APs in the ESS. |
| | According to another embodiment, the timing information can also be |
| | indicated as a single value for one or more APs of a seamless roaming |
| | domain and/or one or more neighbor APs of the transmitting AP and/or |
| | one or more APs in the ESS. |
| | According to one embodiment, an advertising AP can advertise this value |
| | for the seamless roaming domain that it is a part of. |
| | According to one embodiment, an advertising AP can also advertise this |
| | value for seamless roaming domain that it is not a part of. |
| | The transfer time can be a statistic related to the transfer time. For |
| | example, a worse case transfer time, best transfer time, average transfer |
| | time, etc. |
| | The value can be measured by the AP by running periodic ping tests with |
| | the other APs or by other means available in implementation. |
| Network side | One or more information items that can indicate the load on the network |
| load | side that can hinder the transfer of dynamic contexts from one AP to |
| | another. |
| | According to one embodiment, this can also be indicated on a per AP |
| | basis similar to transfer time indication (e.g., individual paths on the |
| | network side between current AP and the other APs) or a cumulative |
| | value for the load on the network side and/or a single value for the load |
| | in the seamless roaming domain. |
| | This information can enable the STA to infer the time for dynamic |
| | context transfer and if it should apply the skip or not. |
| Historic transfer | One or more information items that can indicate the historic transfer time |
| time | for dynamic context for other STAs. |
| | This timing information can be indicated for each context separately or |
| | can be a single value applicable for all contexts. |
| | This timing information can be indicated for one or more APs of a |
| | seamless roaming domain and/or one or more neighbor APs of the |
| | transmitting AP and/or one or more APs in the ESS. |
| | According to another embodiment, the timing information can also be |
| | indicated as a single value for one or more APs of a seamless roaming |
| | domain and/or one or more neighbor APs of the transmitting AP and/or |
| | one or more APs in the ESS. |
| | According to one embodiment, an advertising AP can advertise this value |
| | for the seamless roaming domain that it is a part of. |
| | According to one embodiment, an advertising AP can also advertise this |
| | value for seamless roaming domain that it is not a part of. |
| | This information can be a statistic related to the historic transfer time. |
| | For example, a worse case time, best case time, average time, etc. |
| STA population | One or more information items that can indicate the STA population that |
| for seamless | is currently being serviced by the domain or the current AP for seamless |
| roaming | roaming procedures. This can also be an advertisement of STA |
| | population in general. |
| STA population | One or more information items that can indicate the STA population that |
| that have | has completed the preparation phase. This can be an indication of the |
| completed | STAs that can initiate roaming along with the non-AP. This can be STAs |
| preparation | that have prepared the same APs that the non-AP is intending too. (Here |
| phase | the terms STA and non-AP are used to keep a clarity of reference). |
| STA population | One or more information items that can indicate the STA population that |
| that have started | have started roaming procedure. This can be an indication of the load on |
| roaming | the roaming infrastructure that can hinder the dynamic context transfer of |
| procedure | the non-AP. |
| Allowing a | One or more information items that can indicate if a dynamic context |
| dynamic context | transfer can be allowed or not. |
| transfer | |

### (2). Message Transmission

FIG. 19 illustrates an example method 1900 of an AP side message transmission procedure according to embodiments of the present disclosure. The method 1900 of FIG. 19 can be performed by any of the APs 101, 103 of FIG. 1. The embodiment of the method 1900 shown in FIG. 19 is for illustration only. Other embodiments of the method 1900 could be used without departing from the scope of this disclosure.

As illustrated in FIG. 19, the method 1900 begins at step 1902, where a determination is made whether the AP supports dynamic context transfer skip. If the AP does not support dynamic context transfer skip, then at step 1904, no action is taken. If the AP supports dynamic context transfer skip, then at step 1906, the AP can transmit an AP side parameter info message. Some illustrative examples of an AP side parameter info message are as follows.

### (2.1). Broadcasting Information

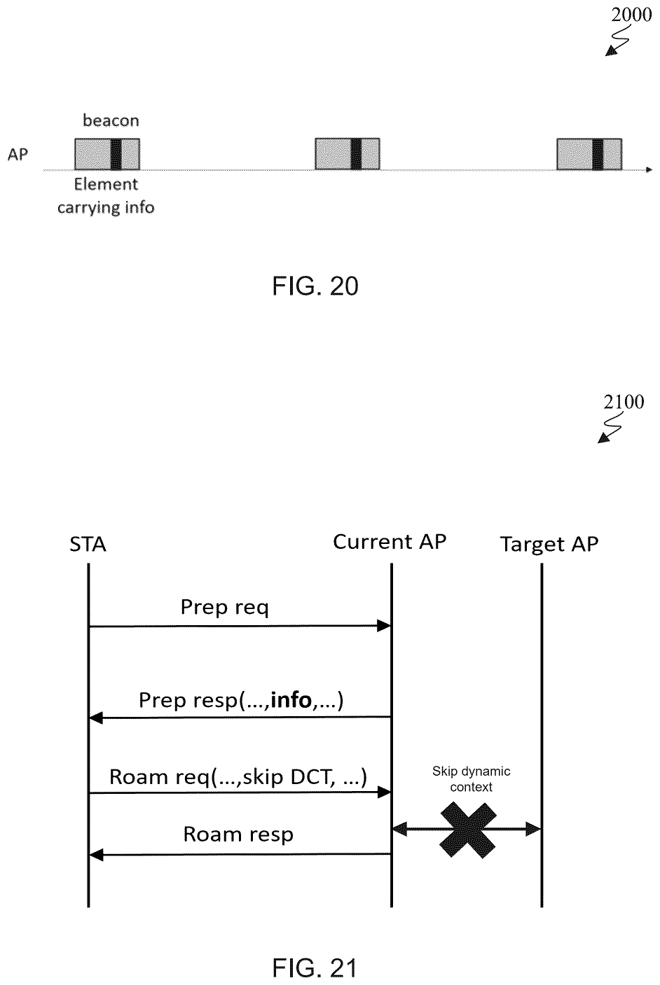

FIG. 20 illustrates an example of broadcasting of AP side information 2000 according to embodiments of the present disclosure. The embodiment of the broadcasting of AP side information 2000 shown in FIG. 20 is for illustration only. Other embodiments of the broadcasting of AP side information 2000 could be used without departing from the scope of this disclosure.

As illustrated in FIG. 20, in some embodiments, the AP can advertise the above message in beacons that it transmits. For instance, the beacons can carry an element that can contain the indication.

In some embodiments, the AP can advertise the above message in a broadcast frame.

In some embodiments, the AP can advertise the above message in a groupcast frame. For example, a frame only for devices that support seamless roaming and can need the information.

### (2.2) Information Exchange Prior to Roaming

FIG. 21 illustrates an example call flow operation 2100 of information exchange prior to roaming during preparation phase according to embodiments of the present disclosure. The call flow operation 2100 of FIG. 21 can be performed by any of the STAs 111-114 of FIG. 1, such as the STA 111 of FIG. 3, and any of the APs 101, 103 of FIG. 1. The embodiment of the call flow operation 2100 shown in FIG. 21 is for illustration only. Other embodiments of the call flow operation 2100 could be used without departing from the scope of this disclosure.

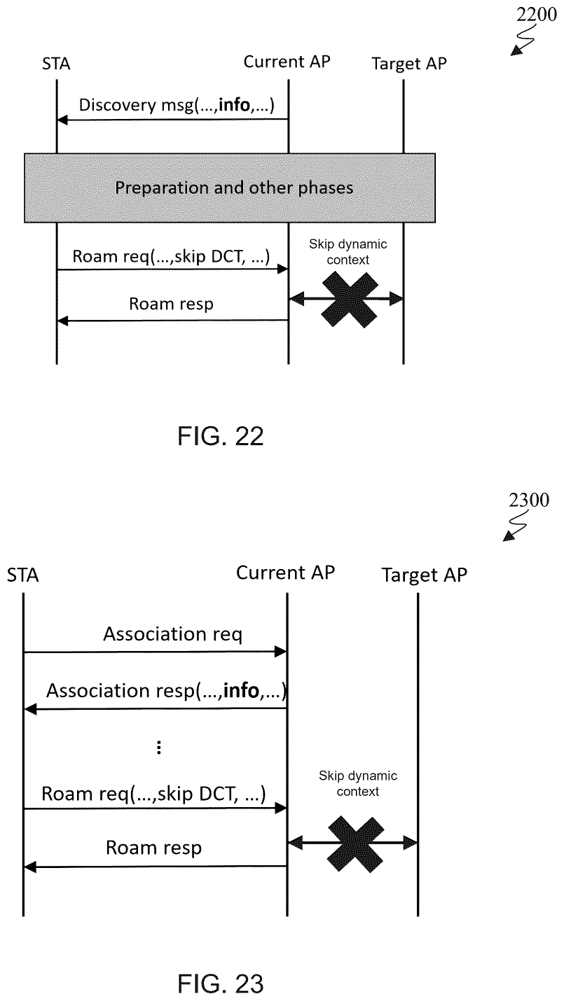

FIG. 22 illustrates an example call flow operation 2200 of information exchange prior to roaming during discovery phase according to embodiments of the present disclosure. The call flow operation 2200 of FIG. 22 can be performed by any of the STAs 111-114 of FIG. 1, such as the STA 111 of FIG. 3, and any of the APs 101, 103 of FIG. 1. The embodiment of the call flow operation 2200 shown in FIG. 22 is for illustration only. Other embodiments of the call flow operation 2200 could be used without departing from the scope of this disclosure.

As illustrated in FIGS. 21-22, the AP can send the message prior to roaming as a part of pre-roam phases. According to some embodiments, as a part of the pre-roaming/preparation/discovery procedure one or more of the information item(s) can be included in a frame that is exchanged. For example, there can be a field in the BTM query/request/response messages that can carry one or more of the information items.

### (2.3) Information Exchange at Association

FIG. 23 illustrates an example call flow operation 2300 of information exchange at association according to embodiments of the present disclosure. The call flow operation 2300 of FIG. 23 can be performed by any of the STAs 111-114 of FIG. 1, such as the STA 111 of FIG. 3, and any of the APs 101, 103 of FIG. 1. The embodiment of the call flow operation 2300 shown in FIG. 23 is for illustration only. Other embodiments of the call flow operation 2300 could be used without departing from the scope of this disclosure.

As illustrated in FIG. 23, the AP can send the message at association/(Re)association. One or more information items can be included as a part of frames exchanged during association/(Re)association. For instance, there can be an element in the association/(Re)association response frame that can carry one or more of the information items.

### (2.4) Information Exchange Upon Association

In some embodiments, the AP can send the message after association. One or more information items can be included as a part of frames exchanged upon association. For example, there can be an action frame that can carry one or more information items in an element or individually.

There can also be a request/response message exchange to make the indication. For example, measurement request/response exchange, a request sent by the non-AP as a part of any of the roaming procedures or a newly defined procedure

### (3). STA Side Behavior

When the STA receives such a message from the AP, the STA can process the message to determine if it needs to perform a dynamic context transfer skip at the time of roaming. If the STA determines that it can skip the dynamic context transfer at the time of roaming, it can make an indication during roaming to skip dynamic context transfer.

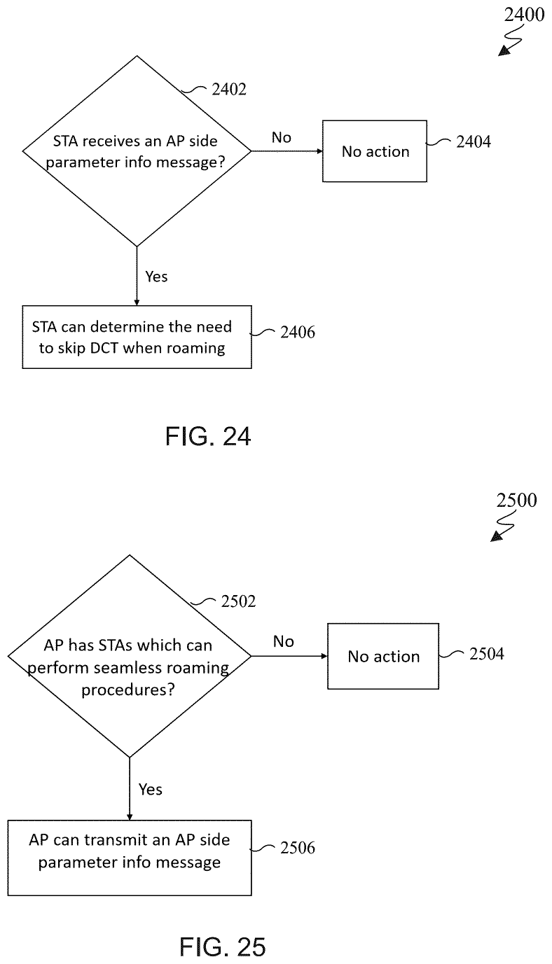

FIG. 24 illustrates an example method 2400 of STA side behavior according to embodiments of the present disclosure. The method 2400 of FIG. 24 can be performed by any of the STAs 111-114 of FIG. 1, such as the STA 111 of FIG. 3. The embodiment of the method 2400 shown in FIG. 24 is for illustration only. Other embodiments of the method 2400 could be used without departing from the scope of this disclosure.

As illustrated in FIG. 24, the method 2400 begins at step 2402, where a determination is made whether the STA receives an AP side parameter info message. If the STA does not receive an AP side parameter info message, then at step 2404, no action is taken. If the STA receives an AP side parameter info message, then at step 2406, the STA can determine the need to skip dynamic context transfer when roaming.

### 4. AP Side Behavior

An AP that has STAs which can skip dynamic context transfer can indicate the info message to its STAs. If a STA chooses to skip dynamic context transfer, then the AP can skip transfer dynamic context at the time of roaming. The target AP can set the value of the parameters in the dynamic context to certain pre-determined values/re-initialize them.

FIG. 25 illustrates an example method 2500 of AP side behavior according to embodiments of the present disclosure. The method 2500 of FIG. 25 can be performed by any of the APs 101, 103 of FIG. 1. The embodiment of the method 2500 shown in FIG. 25 is for illustration only. Other embodiments of the method 2500 could be used without departing from the scope of this disclosure.

As illustrated in FIG. 25, the method 2500 begins at step 2502, where a determination is made whether the AP has STAs that can perform seamless roaming procedures. If the AP does not have STAs that can perform seamless roaming procedures, then at step 2504, no action is taken. If the AP has STAs which can perform seamless roaming procedures, then at step 2506, the AP can transmit an AP side parameter info message.

### 5. Capability Advertisement

In some embodiments, an AP that can allow a dynamic context transfer skip can make the indication in one or more frames that it transmits. For example, in capability bits in management frames. The bit can be set to a predetermined value (e.g., 1) to make the indication and to another predetermined value (e.g., 0) to indicate otherwise.

In some embodiments, a non-AP that can perform a dynamic context transfer skip can make the indication in one or more frames that it transmits. For example, in capability bits in management frames. The bit can also be set to predetermined value (e.g., 1) to make the indication and to another predetermined value (e.g., 0) to indicate otherwise.

The above embodiments can be applicable for both single link and multi-link operation.

### C. Pre-roam Dynamic Context Transfer Skip Procedure

### 1. Opting Out of Dynamic Context Transfer During a Preparation/Pre-Roam Phase

In some embodiments, the STA can opt out of context transfer during a preparation or a pre-roam phase. According to these embodiments, the STA can inform the current AP as a part of the message exchanges during the preparation/pre-roam phase about its intention to opt out of a transfer of one or more items of the dynamic context (e.g., SN). The STA can transmit a request/indication message that can contain such an indication. The request/indication message can contain at least one or more of the information items as indicated in Table 2.

TABLE 2
Information items that can be present in the request/indication message

| Information | |
|---|---|
| items | Description |
| Opting out | One or more information item(s) that can indicate the STA's |
| indication | intent/request/requirement to opt out of a transfer of one or more items of |
| | the dynamic context. For example, a bit/flag that can be set to a |
| | predetermined value (e.g., 1) to make the indication and to another |
| | predetermined value (e.g., 0) to indicate otherwise. |
| Context | One or more information item(s) that can indicate the dynamic context for |
| indication | which the STA can opt out. For example, this can be one or more fields |
| | which can take predetermined values (e.g., 1) to make the indication for a |
| | specific context (e.g., field #1 for SN, field #2 for PN, etc.) and to another |
| | predetermined value (e.g., 0) to indicate otherwise. In another example, |
| | this can also be a bitmap, each of whose bit can correspond to a particular |
| | dynamic context. For example, a 1^{st} bit can correspond to SN, a 2^{nd} bit to |
| | PN, etc. If the value of a bit is set to 1 then it can indicate that that |
| | particular dynamic context can be transferred and to 0 to indicate an opt |
| | out. |
| | The contexts can also be predetermined by the spec and only the opt out |
| | indication can be provided by the STA. |

Upon reception of the above message, the current AP can inform the target AP about the STA's intention to opt out of the transfer of one or more dynamic context.

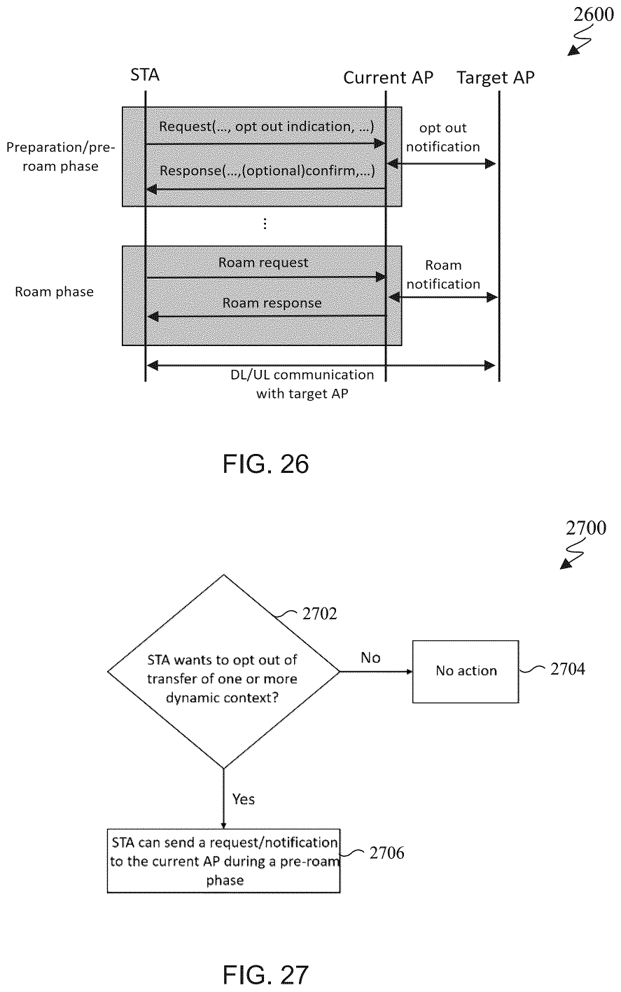

FIG. 26 illustrates an example call flow operation 2600 for pre-roam opt out notification operation according to embodiments of the present disclosure. The call flow operation 2600 of FIG. 26 can be performed by any of the STAs 111-114 of FIG. 1, such as the STA 111 of FIG. 3, and any of the APs 101, 103 of FIG. 1. The embodiment of the call flow operation 2600 shown in FIG. 26 is for illustration only. Other embodiments of the call flow operation 2600 could be used without departing from the scope of this disclosure.

When the target AP receives such a notification from the current AP, the target AP can set the values of such parameters to a predetermined/initialized value, for example, to a value of 0 for SN. When the STA roams to the target AP, the target AP can use these values when handling the STA's packets.

FIG. 27 illustrates an example method 2700 of a STA procedure for pre-roam opt out for dynamic context transfer according to embodiments of the present disclosure. The method 2700 of FIG. 27 can be performed by any of the STAs 111-114 of FIG. 1, such as the STA 111 of FIG. 3. The embodiment of the method 2700 shown in FIG. 27 is for illustration only. Other embodiments of the method 2700 could be used without departing from the scope of this disclosure.

As illustrated in FIG. 27, the method 2700 begins at step 2702, where a determination is made whether the STA wants to opt out of transfer of one or more dynamic context. If the STA does not want to opt out of transfer of one or more dynamic context, then at step 2704, no action is taken. If the STA wants to opt out of transfer of one or more dynamic context, then at step 2706, the STA can send a request/notification to the current AP during a pre-roam phase.

### 2. Opting Out of Dynamic Context Transfer During Roam Phase

The STA can opt out of dynamic context transfer during the roam phase. According to this embodiment, the STA can inform the current AP as a part of the message exchanges during the roam phase about its intention to opt out of a transfer of one or more items of the dynamic context (e.g., SN). The STA can transmit a request/indication message that can contain such an indication. The request/indication message can contain at least one or more of the information items as indicated in Table 2 herein.

According to some embodiments, if the target AP can have a default mode of operation. As a part of this mode of operation, the target AP can set the values of such parameters to a predetermined/initialized value, for example, to a value of 0 for SN. When the STA roams to the target AP, the target AP can use these values when handling the STA's packets. If the STA chooses to perform a dynamic context transfer to the target AP, then the target AP can change these values to the ones that are transferred over from the current AP during the roam phase.

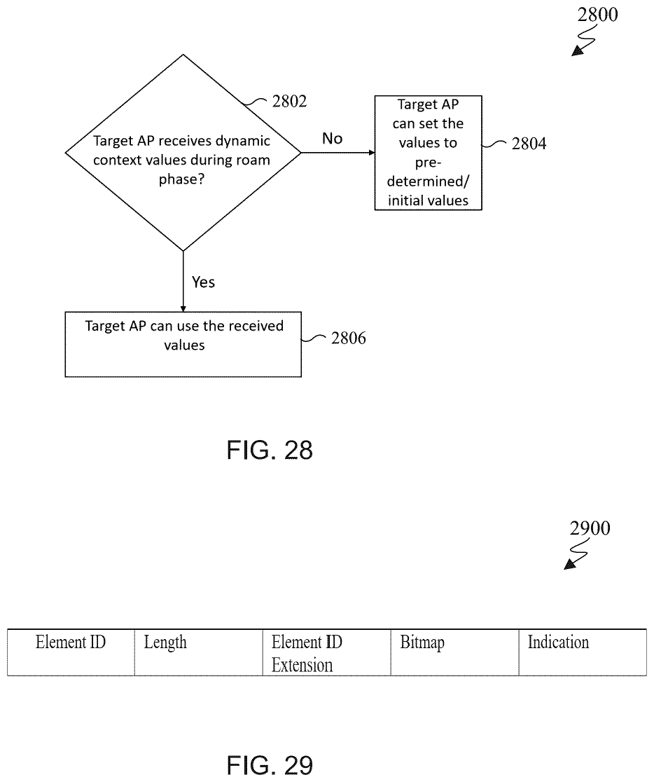

FIG. 28 illustrates an example method 2800 of a target AP procedure during roam phase dynamic context transfer opt out according to embodiments of the present disclosure. The method 2800 of FIG. 28 can be performed by any of the APs 101, 103 of FIG. 1. The embodiment of the method 2800 shown in FIG. 28 is for illustration only. Other embodiments of the method 2800 could be used without departing from the scope of this disclosure.

As illustrated in FIG. 28, the method 2800 begins at step 2802, where a determination is made whether the target AP receives dynamic context values during the roam phase. If the target AP does not receive dynamic context values during the roam phase, then at step 2804, the target AP can set the values to predetermined/initial values. If the target AP receives dynamic context values during the roam phase, then at step 2806, the target AP can use the received values.

### 3. Example Signaling

FIG. 29 illustrates an example element 2900 that can carry signaling according to embodiments of the present disclosure. The embodiment of the example element 2900 shown in FIG. 29 is for illustration only. Other embodiments of the example element 2900 could be used without departing from the scope of this disclosure.

As illustrated in FIG. 29, according to some embodiments, the indication can be carried in a BTM message (query/request/response). According to some embodiments, there can be an element that can carry the indication.

In some embodiments, the element can be carried in a BTM message. The BTM messages can be used for pre-roam request/response indication.

In some embodiments, one or more of the above fields can also be present in a link reconfiguration message that indicates an add link. This can be useful when making the indication during the roam phase.

In some embodiments, one or more of the above fields can also be present in a (Re)association request frame. This can be useful when making the indication during the roam phase in an enhanced FT mobility domain.

### 4. Capability Indication

In some embodiments, an AP that has the capability to support a dynamic context transfer opt out can make an indication in one or more frames that it transmits. For example, management frames such as beacons, probe response, etc. This can enable a STA to understand the AP's capability.

In some embodiments, a STA that has the capability to support a dynamic context transfer opt out can make an indication in one or more frames that it transmits. For example, management frames such as (Re)association requests.

The above embodiments can be used for near static context transfer as well.

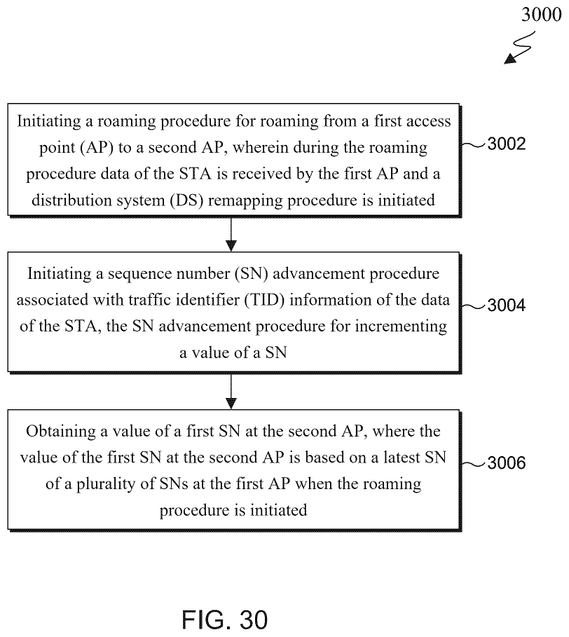

FIG. 30 illustrates an example method 3000 performed by a STA in a wireless communication system according to embodiments of the present disclosure. The method 3000 of FIG. 30 can be performed by any of the STAs 111-114 of FIG. 1, such as the STA 111 of FIG. 3. The method 3000 is for illustration only and other embodiments can be used without departing from the scope of the present disclosure.

As illustrated in FIG. 30, the method 3000 begins at step 3002, where the STA initiates a roaming procedure for roaming from a first AP to a second AP, wherein during the roaming procedure, data of the STA is received by the first AP and a DS remapping procedure is initiated. At step 3004, the STA initiates an SN advancement procedure associated with TID information of the data of the STA, the SN advancement procedure for incrementing a value of a SN. At step 3006, the STA obtains a value of a first SN at the second AP, where the value of the first SN at the second AP is based on a latest SN of a plurality of SNs at the first AP when the roaming procedure is initiated.

In some embodiments, the value of the first SN at the second AP is based on a value of a size of an SN buffer added to the value of the latest SN of the plurality of SNs.

In some embodiments, the value of the first SN at the second AP is based on a value of a fixed offset from the latest SN of the plurality of SNs added to the value of the latest SN of the plurality of SNs.

In some embodiments, the value of the first SN at the second AP is based on a duration of time from the latest SN of the plurality of SNs during which the value of the latest SN of the plurality of SNs is incremented.

In some embodiments, the value of the first SN at the second AP is based only on the value of the latest SN of the plurality of SNs.

In some embodiments, the value of the first SN at the second AP is based on a value of a SN at a time of initiation of the DS remapping.

In some embodiments, the SN advancement procedure is the same for all TIDs.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A station (STA) comprising:
a transceiver; and
a processor operably coupled with the transceiver, the processor configured to:
initiate a roaming procedure for roaming from a first access point (AP) to a second AP, wherein during the roaming procedure, data of the STA is received by the first AP and a distribution system (DS) remapping procedure is initiated;
initiate a sequence number (SN) advancement procedure associated with traffic identifier (TID) information of the data of the STA, the SN advancement procedure for incrementing a value of a SN; and
obtain a value of a first SN at the second AP, wherein the value of the first SN at the second AP is based on a latest SN of a plurality of SNs at the first AP when the roaming procedure is initiated.

2. The STA of claim 1, wherein the value of the first SN at the second AP is based on a value of a size of an SN buffer added to the value of the latest SN of the plurality of SNs.

3. The STA of claim 1, wherein the value of the first SN at the second AP is based on a value of a fixed offset from the latest SN of the plurality of SNs added to the value of the latest SN of the plurality of SNs.

4. The STA of claim 1, wherein the value of the first SN at the second AP is based on a duration of time from the latest SN of the plurality of SNs during which the value of the latest SN of the plurality of SNs is incremented.

5. The STA of claim 1, wherein the value of the first SN at the second AP is based only on the value of the latest SN of the plurality of SNs.

6. The STA of claim 1, wherein the value of the first SN at the second AP is based on a value of a SN at a time of initiation of the DS remapping.

7. The STA of claim 1, wherein the SN advancement procedure is same for all TIDs.

8. A first access point (AP) comprising:
a transceiver; and
a processor operably coupled with the transceiver, the processor configured to:
perform a roaming procedure associated with a station (STA) roaming from the first AP to a second AP, wherein during the roaming procedure, data of the STA is received by the first AP and a distribution system (DS) remapping procedure is initiated; and
perform a sequence number (SN) advancement procedure associated with traffic identifier (TID) information of the data of the STA, the SN advancement procedure for incrementing a value of a SN,
wherein to perform the SN advancement procedure, the processor is further configured to:
determine a value of a latest SN of a plurality of SNs at the first AP when the roaming procedure is initiated; and
transmit, via the transceiver to the second AP, information associated with determination of a value of a first SN at the second AP based on the determined value of the latest SN of the plurality of SNs.

9. The first AP of claim 8, wherein the information associated with determination of the value of the first SN at the second AP comprises a value of a size of an SN buffer added to the value of the latest SN of the plurality of SNs.

10. The first AP of claim 8, wherein the information associated with determination of the value of the first SN at the second AP comprises a value of a fixed offset from the latest SN of the plurality of SNs added to the value of the latest SN of the plurality of SNs.

11. The first AP of claim 8, wherein the information associated with determination of the value of the first SN at the second AP is based on a duration of time from the latest SN of the plurality of SNs during which the value of the latest SN of the plurality of SNs is incremented.

12. The first AP of claim 8, wherein the information associated with determination of the value of the first SN at the second AP is based only on the value of the latest SN of the plurality of SNs.

13. The first AP of claim 8, wherein the information associated with determination of the value of the first SN at the second AP is based on a value of a SN at a time of initiation of the DS remapping.

14. The first AP of claim 8, wherein the SN advancement procedure is same for all TIDs.

15. A method of wireless communication performed by a station (STA), the method comprising:
initiating a roaming procedure for roaming from a first access point (AP) to a second AP, wherein during the roaming procedure, data of the STA is received by the first AP and a distribution system (DS) remapping procedure is initiated;
initiating a sequence number (SN) advancement procedure associated with traffic identifier (TID) information of the data of the STA, the SN advancement procedure for incrementing a value of a SN; and
obtaining a value of a first SN at the second AP, wherein the value of the first SN at the second AP is based on a latest SN of a plurality of SNs at the first AP when the roaming procedure is initiated.

16. The method of claim 15, wherein the value of the first SN at the second AP is based on a value of a size of an SN buffer added to the value of the latest SN of the plurality of SNs.

17. The method of claim 15, wherein the value of the first SN at the second AP is based on a value of a fixed offset from the latest SN of the plurality of SNs added to the value of the latest SN of the plurality of SNs.

18. The method of claim 15, wherein the value of the first SN at the second AP is based on a duration of time from the latest SN of the plurality of SNs during which the value of the latest SN of the plurality of SNs is incremented.

19. The method of claim 15, wherein the value of the first SN at the second AP is based only on the value of the latest SN of the plurality of SNs.

20. The method of claim 15, wherein the value of the first SN at the second AP is based on a value of a SN at a time of initiation of the DS remapping.
